(19) United States
(12) Patent Application Publication
(10) Pub. No.: US 2021/0144123 A1
(43) Pub. Date: May 13, 2021

(54) SERIALIZATION OF FIREWALL RULES WITH USER, DEVICE, AND APPLICATION CORRELATION

(71) Applicant: Wells Fargo N.A., Charlotte, NC (US)

(72) Inventors: Justin Dunn, Yadkinville, NC (US); Artemio V. Meras, III, San Antonio, TX (US); Brian Schlemmer, Charlotte, NC (US); Shawn M. Craig, Charlotte, NC (US); Duncan Molony, New Orleans, LA (US); Christopher Houser, Mt. Holly, NC (US); Michael Scott Hopkins, Millstadt, IL (US); Kerrie Heller, Stanley, NC (US); Michael Dutilly, Waxhaw, NC (US); Christy K. Lewis Lester, Brandon, SD (US); Jonathan Louis Gabel, Charlotte, NC (US)

(21) Appl. No.: 15/073,026

(22) Filed: Mar. 17, 2016

(51) Int. Cl. H04L 29/06; G06F 17/30

(52) U.S. Cl. CPC H04L 63/02; G06F 17/30321; H04L 63/0236; H04L 63/20

(57) ABSTRACT

The innovation disclosed and claimed herein, in one aspect thereof, comprises systems and methods of serializing firewall rules and their relationships to users, devices, and/or applications. Distributed firewalls in a large network are scanned for firewall rules which are discovered and indexed in a centralized rule database. The firewall rules are indexed according to different categories of data. The firewall rules can be updated in the database and at the distributed firewall. The firewall rules can be matched to the rule source and be verified.

### BACKGROUND

Distributed networks call for detailed management of a variety of factors. Managing what and/or who has access to an internal network, such as for a business, is often time intensive and complicated. Firewall rules dictate and grant access on an individual user, device, and/or application basis. Further, it is difficult to identify what user, device, and/or application may be utilizing a given firewall rule as well running analysis against large-scale firewall deployments.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of serializing firewall rules with user, device, and/or application correlation. Distributed firewalls in a network are scanned for firewall rules which are discovered and indexed in a centralized rule database. The firewall rules are indexed according to different categories of data. The firewall rules can be updated in the database and at the distributed firewall. The firewall rules can be matched to the rule source and be verified.

In aspects, the subject innovation provides substantial benefits in terms of firewall management and servicing. One advantage resides in a more standardized index of firewall rules and/or policies. Another advantage resides in real time or near real time updating and monitoring and vice versa of new and old firewall rules.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a system diagram for serializing firewall rules.

FIG. 2 illustrates an example component diagram of a discovery component.

FIG. 3 illustrates an example component diagram of an analysis component.

FIG. 4 illustrates an example component diagram of an association component.

FIG. 5 illustrates an example input/output diagram for a firewall rule in a distributed firewall processed into a rule database with user, device, and/or application correlation.

FIG. 6 illustrates a flowchart to serialize firewall rules for a network.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

With reference to FIG. 1, a system 100 for serializing firewall rules is depicted. A management component 110 resides on a network such as a corporation wide network and/or intranet. The management component 110 includes a discovery component 120.

The discovery component 120 accesses distributed firewalls 130. The distributed firewalls 130 are a system of firewalls managed by an entity throughout a network. Typically, a firewall is managed by one or more network administrators. The distributed firewalls 130 are distributed across a network and interact with the network to control access. The distributed firewalls 130 determine what is allowed acccess to the network or what type of traffic is allowed. In one embodiment, the network can be a corporation wide network that provides online services and/or access to corporate sites and/or information. The firewalls control access for internal and/or external users of the network. Further, the firewalls can control access to different parts of the network such that only part of the network may be available to certain users and/or applications. The firewalls can be divided according to geographic area, applications, users, user types, and/or a combination thereof, among others.

The discovery component 120 discovers or mines the distributed firewalls 130 across the network for firewall rules. The discovery component 120 can use data mining algorithms, searching algorithms, and/or the like. The distributed firewalls 130 are accessed individually by the discovery component 120. For example, the discovery component 120 accesses Firewall₁ 140, Firewalls 150, to Firewall_{N} 160 of the distributed firewalls 130. Each firewall, i.e. 1 . . . N, has a set of firewall rules, e.g. policies, stored locally at the firewall.

The discovery component 120 discovers firewall rules from each firewall of the distributed firewalls 130. The discovery component 120 discovers the firewall rules and stores the firewall rules in a rule database 170. With reference to FIG. 2, the discovery component 120 includes a communication component 210. The communication component 210 can connect to a mobile network, wired LAN, wireless LAN, an internet network, or the like to transmit communications. The communication component 210 connects to a transmission server to send and receive data, alerts, or the like to and from networked devices. In one embodiment, the mode of the communication can be an application programming interface (API), and/or the like. The communication component 210 accesses the distributed firewalls 130 over the network. The communication component 210 accesses each firewall individually, i.e. 1 . . . N, and discovers existing firewall rules from each firewall. The discovered rules 170 can be stored in a rule database 170.

In one embodiment, the communication component 210 monitors the firewall for newly created firewall rules. The communication component 210 detects a newly created firewall rule at a distributed firewall. The communication component 210 discovers the new firewall rule and communicates the rule for storage at the rule database 170.

In one embodiment, the discovery component 120 includes a mapping component 220. Typically, firewall rules contain mostly the same data; however, different firewalls can dictate firewall rules in different formats. For example, the firewall rule format can vary by firewall manufacturer. The mapping component 220 converts a firewall rule in a different format into a conventional or standardized format that can be parsed or indexed.

The discovery component 120 includes an analysis component 230. The analysis component 230 performs operations on the firewall rules or manipulates data of the firewall rules. With reference to FIG. 3 and continuing reference to FIG. 2, the analysis component 230 includes an index component 310. The index component 310 mines each firewall rule for data to be indexed in the database. The index component 310 populates data fields of the database, the fields being data categories belonging to each firewall rule. For example, the data and/or data fields can be rule name, source, destination, services, last usage date, hit count, last certification date, last certification status, and/or the like.

The analysis component 230 includes a sorting component 320. The sorting component 320 creates data-tags for each rule in the rule database 170. The sorting component 320 parses the data in each data field. The sorting component 320 converts the parsed data into data-tags, e.g. text strings that can be logged and keyword searched. The data-tags can be searchable such that rules in the rule database 170 can be easily found according to search criteria. For example, a user can search for all rules with the same destination IP address.

The analysis component 230 includes an association component 330. The association component 330 determines assets that are associated with each rule. With reference to FIG. 4, the association component 330 accesses other data sources, e.g. other network information/sources or the like, to associate a firewall rule to a source, e.g. an application. For example, the association component can include an asset database 410 or be in communication with an asset database residing elsewhere on the network. The asset database 410 can include a device IP address associated with a device of a user. The device IP address can be associated or matched to a source IP address of a rule in the rule database 170 to determine ownership of the rule. The rule will be associated with the specific user device in the rule database 170.

In another example, the association component 330 includes a traffic component 420. The traffic component 420 can read data packets, domain name system (DNS) data, net mask data, and/or network traffic to correlate an application and a firewall rule. The traffic component 420 can access a data log or monitor traffic for source IP addresses and destination IP addresses. The traffic component 420 can discover the application that is generating the network traffic. The association component 330 associates the application's generated network traffic read by the traffic component 420 that has the same source and destination IP addresses as a firewall rule to determine ownership of that rule. The determined ownership of a rule is stored in the rule database 170 in an asset data field and can be data-tagged by the sorting component 320.

With continuing reference to FIG. 3, the analysis component 230 includes a verification component 340. The verification component 340 determines whether the source using a particular rule, e.g. the source IP address, is authenticated. The verification component 340 can obtain 3^{rd} party verification of the rule from a user. In one embodiment, the verification component 340 can generate a 1-time code. The verification component 340 sends the 1-time code to the owner over a transmission server 350 having a processor and a memory to a user device 360. The user receives the 1-time code on the user device 360 and responds with the code either over the transmission server 350 or at the distributed firewalls 130. The verification component 340 receives the 1-time code back from the user over the transmission server 350 from the user device 360. The verification component 340 determines the sent 1-time code and the received 1-time code match. It is appreciated that this is just one specific example of 3^{rd} party authentication. Other forms of authentication are contemplated, such as, but not limited to, voice recognition, image recognition, fingerprint recognition, biometric recognition, and/or the like.

With continuing reference to FIG. 1, in one embodiment, a network administrator can review each firewall rule in the rule database 170 to verify the extracted information for correctness and currency. The review can be at time of creation or a periodic review by the network administrator. The management component 110 can include a user interface 190 to receive user input for manipulating or changing data in a data field. The network administrator can make changes to a rule via the user interface 190 of the management component 110. The network administrator can create a comments data field to attach notes about a particular rule. The network administrator can modify operative parts of a rule in a respective data field. For example, the network administrator can change the destination IP address of a rule in the rule database 170 via the user interface 190. The management component 110 can receive the change in the firewall rule and make the change at the distributed firewalls 130 over the network such that it becomes operative at the firewall.

With reference to FIG. 5, an example input/output diagram 500 is depicted for a firewall rule in a distributed firewall processed into a rule database. The input to the system begins with a firewall rule 502. The firewall rule is passed to a rule serializer 504. The rule serializer 504 divides the firewall rule 502 into smaller data parcels 506. The data parcels 506 for a firewall rule 502 can include a source, a destination, and services. The source can be a starting IP address where network data packets are originated. The destination can be an end IP address where network data packets are directed towards. The service can be the type of network data that can be allowed or denied by the firewall to a network.

Typically, firewall rules include objects. The firewall rule 502 can be parsed into objects, e.g. portions of function data, which define how the firewall rule 502 operates in the firewall. Objects can be classified by object type 508. The object type 508 can be categorized according to function. Object types 508 can be a network object 510, a service object 512, and/or a group 514. A network object 510 can define a host, a range of IP addresses, a network IP address, and/or other. The network object 510 is mapped 516 to NetworkObject DataFields 518. The NetworkObject DataFields 518 are standardized data fields that can be uniform for each rule in a rule database. The NetworkObject DataFields 518 include Name, IPAddress, NetMask, IPAddrStart, IPAddrEnd, Type, among others.

Some objects may not translate directly into each data field. The system can follow a mapping rubric or logic to map object data to an appropriate data field. For example, a host network object includes only one IP address for a host. In the example, the host IP address is mapped 516 to both the IPAddrStart and IPAddrEnd data fields. In another example, a range of IP addresses network object includes a sequential list of IP addresses with a start and an end. The start and end of the range of IP addresses can be mapped 516 to the IPAddrStart and IPAddrEnd data fields respectively. In yet another example, a network IP address object includes an IPAddr/NetMask and a NetMask. The IPAddr/NetMask can be mapped 516 to IPAddrStart and IPAddrEnd data fields, and the NetMask is mapped to the NetMask data field. In another example, another network object includes properties that can be parsed and populate the Network Object DataFields 518.

A service object 512 includes properties that can be mapped 516 to ServiceObject DataFields 520. ServiceObject DataFields 520 can include data fields such as name, port, protocol, type, and/or the like. A group 517 can be mapped 516 to a GroupHierarchy 522. The GroupHierarchy 522 can include data fields such as parent, child, and/or the like.

For network objects 510, the NetworkObject DataFields 518 are passed to an association engine 524. In particular, the IPAddrStart and IPAddrEnd data fields can be passed to the association engine 524. The association engine 524 determines an asset associated with the network object 510. An asset can be an application, user device, account, and/or the like. The association engine 524 accesses an asset configuration management database (CMDB) 526. The asset CMDB 526 includes DNS entries and/or other asset IP SOR information. The association engine 524 associates the IPAddrStart and IPAddrEnd data fields to an asset IPAddress data field in the asset CMDB 526. The association engine 524 can determine 528 whether the asset IP address is within range of the IPAddrStart and IPAddrEnd to determine an association. If within range, an association is created between the network object 510 or firewall rule 502 and the asset. The NetworkObject DataFields 518, ServiceObject DataFields 520, and/or GroupHiearchy 522 are stored in a Firewall Rule—Asset Database 530. The Firewall Rule—Asset Database 530 associates the data fields with the firewall rule 502 and the determined relationship between the asset and the firewall rule 502.

With reference to FIG. 6, an example method 600 is depicted for customer verification of firewall rules. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 600 is described in conjunction with a specific example is for explanation purposes.

In aspects, method 600 can begin at 610 by accessing firewalls that are distributed across a network. Firewall rules are stored locally at each firewall location. For example, a firewall rule residing at a distributed firewall dictates a user device having access to only user account server on the corporate network and not elsewhere on the network. The firewall rule can limit traffic to only data packets that have a source IP address of the user device and a destination IP address of the user account server. At 620, the firewall rules are extracted from each distributed firewall. The firewall rules can be accessed and discovered via an API call and response and/or the like. The firewall rules are extracted to a database. The database can be networked or offline. Continuing the example, the firewall rule is copied at the distributed firewall and stored in the database. At 630, the firewall rules are indexed. The firewall rules are parsed for data. The data is indexed into data fields of a database entry. In the example, the firewall rule is divided into data fields. The data fields for this specific example can be a rule name, the source IP address, and/or the destination IP address.

At 640, searchable data-tags are created for the firewall rules. The data in each data-field is parsed into text that can be searchable within the database. In the example, the source IP address data field can be parsed and tagged such that it is searchable in the database. The destination IP address and/or the name data fields can be parsed and tagged accordingly. In one embodiment, the IP addresses can be converted to binary to facilitate searching. At 650, the firewall rules can be matched to assets of the rules. For example, an asset can be a user, application, device, and/or the like. Each rule can be associated with an asset. A data-field in the database entry for a particular rule is created and populated with a determined asset. The ownership data-field can be tagged and made searchable in the database. In the example, the asset of the rule can be the user account associated with the user device, or the user device itself. The source IP address and destination IP address can be matched to known source IP address and destination IP address in the user account server as belonging to a particular user account. The user account is associated with the firewall rule in the database.

At 660, the asset can be verified. The verification can use 3^{rd} party verification to authenticate the ownership. The verification can be a 1-time code sent to a user device, voice recognition, image recognition, fingerprint recognition, biometric recognition, and/or the like. For example, the associated user account can contain include a user phone number. A 1-time code can be sent to the user phone number. A user can input the 1-time code in the network when accessing the user account server to verify the association with the rule.

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

With reference to FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a computing device 802 configured to implement one or more embodiments provided herein. In one configuration, computing device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be accessed in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media can be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for computing device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for serializing firewall rules, comprising:
remotely discovering, by a processor, a set of firewall rules representing every firewall rule on a network from a set of firewalls representing every firewall residing on the network over the network using a data mining algorithm;
storing the set of firewall rules in a rule database remote from the set of firewalls;
associating a firewall rule in the set of firewall rules with an asset, the asset being a user account in an asset database, wherein the association compares information of the firewall rule to corresponding asset information in the asset database;
identifying the user account of the firewall rule from the association;
verifying the association between the firewall rule and the asset from the user account of the firewall rule;
monitoring the set of firewalls for new firewall rules;
remotely detecting, in real time, a new rule created at the set of firewalls; and
storing the new rule in the rule database.

2. The method of claim 1, comprising:
discovering at least two firewall rules from the set of firewalls, wherein the at least two firewall rules are in different formats; and
mapping the at least two firewall rules into a uniform rule format for storing in the rule database.

3. The method of claim 2, wherein the mapping comprises:
determining different objects of each firewall rule; and
mapping the different objects into data fields of a rule database according to a mapping rubric defining the mapping.

4. The method of claim 5, wherein the associating comprises:
matching an IP address in the indexed information of the firewall rule to an IP address from the asset in the asset database.

5. The method of claim 1, comprising:
indexing information from the firewall rule, the information organized into data fields.

6. The method of claim 5, comprising:
creating searchable data-tags for the indexed data fields.

7. (canceled)

8. The method of claim 1, wherein the verification comprises:
generating a 1-time code;
sending the 1-time code to the user account over a transmission server having a processor and a memory to an asset device;
receiving the 1-time code back from the user account over the transmission server from the asset device; and
determining the sent 1-time code and the received 1-time code match.

9. (canceled)

10. A system for serializing firewall rules, comprising:
a discovery component that remotely discovers a set of firewall rules from a set of firewalls residing on a network using a data mining algorithm;
a database that stores the set of firewall rules in a rule database remote from the set of firewalls;
an association component that associates a firewall rule in the set of firewall rules with an asset, the asset being a user account;
a verification component that:
identifies the user account of the firewall rule from the association; and
verifies the association between the firewall rule and the asset from the user account of the firewall rule; and
a communication component that monitors the set of firewalls for new firewall rules, the monitoring includes:
remotely detecting, in real time, a new rule being created at the set of firewalls; and
storing the new rule in the rule database for analysis by the analysis component.

11. The system of claim 14, further comprising:
the association component matches an IP address in the indexed information of the firewall rule to an IP address from an asset.

12. The system of claim 10, comprising:
a communication component that discovers at least two firewall rules from the set of firewalls, wherein the at least two firewall rules are in different formats; and
a mapping component that converts the at least two firewall rules into a uniform rule format for storing in the rule database.

13. The system of claim 10, comprising:
an analysis component that analyzes the firewall rule to establish data fields or associations of the firewall rule.

14. The system of claim 10, wherein the analysis component comprises:
an index component that indexes information from the firewall rule, the information organized into data fields.

15. The system of claim 14, wherein the analysis component comprises:
a sorting component that creates searchable data-tags for the indexed data fields.

16. (canceled)

17. The system of claim 10, wherein the verification component:
generates a 1-time code;
sends the 1-time code to the user account over a transmission server having a processor and a memory to an asset device;
receives the 1-time code back from the user account over the transmission server from the asset device; and
determines the sent 1-time code and the received 1-time code match.

18. (canceled)

19. A computer readable medium having instructions to control one or more processors configured to:
remotely discover a set of firewall rules from a set of firewalls on a network using a data mining algorithm;
store the set of firewall rules in a rule database remote from the set of firewalls;
index information from the at least one firewall rule, the information organized into data fields;
create searchable data-tags for the indexed information data fields;
match the at least one firewall rule with an asset, the asset being a user account;
identify the user account of the at least one firewall rule from the matching;
verify the match between the at least one firewall rule and the asset from the user account of the firewall rule;
remotely detect, in real time, a newly created rule at the set of firewalls; and
store the newly created rule in the rule database for analysis.

20. The computer readable medium of claim 19, wherein the matching includes the one or more processors further configured to:
verifying asset ownership by matching an IP address in the indexed information to an IP address from an application.

21. The method of claim 1, comprising:
monitoring network traffic over a network that uses the firewall rule, wherein the monitoring the network traffic is used to determine data about the firewall rule; and
discovering an asset that is using the firewall rule and is generating network traffic based on the determined data about the firewall rule.

22. The system of claim 10, comprising:
a traffic component that:
monitors network traffic over a network that uses the firewall rule, wherein the monitoring the network traffic is used to determine data about the firewall rule; and
discovers an asset that is using the firewall rule and is generating network traffic based on the determined data about the firewall rule.
